(19) United States
(12) Patent Application Publication
(10) Pub. No.: US 2025/0334683 A1
(43) Pub. Date: Oct. 30, 2025

(54) TEST AND/OR MEASUREMENT INSTRUMENT AND TEST SYSTEM FOR TESTING AN OPTOELECTRONIC DEVICE UNDER TEST

(71) Applicant: Rohde & Schwarz GmbH & Co. KG, Muenchen (DE)

(72) Inventor: Jan Horn, Muenchen (DE)

(21) Appl. No.: 18/647,213

(22) Filed: Apr. 26, 2024

(51) Int. Cl. G01S 7/497; G01S 17/58

(52) U.S. Cl. CPC G01S 7/497; G01S 17/58

(57) ABSTRACT

The present disclosure relates to a test and/or measurement instrument for testing an optoelectronic device under test, comprising an arbitrary waveform generator circuit configured to provide at least one stimulus signal for the optoelectronic device under test, a synchronizing circuit configured to provide at least one synchronization signal for the optoelectronic device under test, a signal capturing circuit configured to capture at least one analog signal from the optoelectronic device under test. The test and/or measurement instrument is configured to determine at least one frequency-modulated continuous wave, FMCW, based signal component. Further, a test system is described.

### FIELD OF THE DISCLOSURE

Embodiments of the present disclosure relate to a test and/or measurement instrument for testing an optoelectronic device under test. Further, embodiments of the present disclosure relate to a test system for testing an optoelectronic device under test.

### BACKGROUND

In the state of the art, it is known to use radar systems like frequency-modulated continuous wave (FMCW) radar systems for different applications. For instance, those radar systems are used in automotive applications. When developing such a radar system, it is necessary to test and/or measure the radar system, for example prototypes, in order to verify the functionality and to detect certain aspects that need to be redesigned. For these tests, test and/or measurement instruments are known that already support designing, testing and analyzing these kinds of radar systems.

In the meantime, a shift from radar systems to light detection and ranging, LiDAR, systems has taken place, e.g. in automotive applications as well as other application areas. The LiDAR systems used in the state of the art are based on a straightforward time of flight (ToF) principle. For this kind of LiDAR systems, a broad market rollout in automotive and other applications is already ongoing right now.

It is however believed that the LiDAR systems—similar to radar systems—will also move towards FMCW principle such that FMCW LiDAR systems will be implemented in several applications in the future. So far, no reliable test and/or measurement instruments exist which could be used to test this kind of optoelectronic devices, namely FMCW LiDAR systems.

Accordingly, there is a need for a test and/or measurement instrument as well as a test system which are suitable for testing an optoelectronic device under test, namely a FMCW LiDAR system, in order to assist developers when designing respective FMCW LiDAR systems.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a test and/or measurement instrument for testing an optoelectronic device under test. In an embodiment, the test and/or measurement instrument comprises an arbitrary waveform generator circuit configured to provide at least one stimulus signal for the optoelectronic device under test and/or to receive at least one synchronization signal from the optoelectronic device under test. The test and/or measurement instrument also comprises a synchronizing circuit configured to provide at least one synchronization signal for the optoelectronic device under test. Further, the test and/or measurement instrument comprises a signal capturing circuit configured to capture at least one analog signal from the optoelectronic device under test. The test and/or measurement instrument is configured to determine at least one frequency-modulated continuous wave (FMCW) based signal component.

Further, embodiments of the present disclosure provide a test system for testing an optoelectronic device under test. In an embodiment, the test system comprises the optoelectronic device under test and the test and/or measurement instrument as described above.

The main idea of the present disclosure is to provide a test and/or measurement instrument that comprises several components which can be used in different operation modes of the test and/or measurement instrument in order to perform different tests on the optoelectronic device under test, namely a fully implemented FMCW LiDAR system or components thereof. Hence, the optoelectronic device under test may be a FMCW LiDAR system that is tested by the test and/or measurement instrument or component(s) of the FMCW LiDAR system, for instance an optical generation component like a laser. Accordingly, different tests and/or measurements are performed in order to completely characterize the FMCW LiDAR system and/or its individual components.

During the development of the optoelectronic device, prototype creation and testing, there are various tasks where enhanced basic signal acquisition and analysis features of the test and/or measurement instrument can be used. In addition, the final digital signal processing, DSP, hardware of the FMCW LiDAR system is not available early enough to assess the performance of the prototypes. Therefore, it is beneficial to be able to do evaluations with a test and/or measurement instrument early in the project scope.

In an embodiment, the test and/or measurement instrument used for testing the optoelectronic device under test might process at least an output signal of the optoelectronic device under test, namely the analog signal received. When processing the analog signal received, the test and/or measurement instrument determines at least one FMCW based signal component based on which the further processing and/or analysis is done in order to characterize the optoelectronic device under test, namely the FMCW LiDAR system or component(s) of the FMCW LiDAR system.

In an embodiment, the test and/or measurement instrument has at least one analog channel that is connected with the signal capturing circuit. Therefore, the analog signal outputted by the optoelectronic device under test can be received via the at least one analog channel of the test and/or measurement instrument for further processing.

In an embodiment, the arbitrary waveform generator circuit may be established to perform digital synthesis in order to generate an arbitrary waveform used for testing/measuring the optoelectronic device under test. In an embodiment, the arbitrary waveform may be created by the arbitrary waveform generator circuit from a single, fixed-frequency reference clock. The arbitrary waveform generator circuit may comprise a Direct Digital Synthesizer, DDS, that comprises a frequency reference, a numerically controlled oscillator, NCO, and a digital-to-analog converter, DAC.

It can be assumed that a FMCW LiDAR system, namely the corresponding optoelectronic device under test, might use pure up-chirps and down-chirps. In this case, there is a constant beat frequency in the up-chirp, fbu, and a constant beat frequency in the down-chirp, fbd. The beat frequency relates to the frequency of a beat signal which is obtained by the FMCW LiDAR system, e.g. the optoelectronic device under test, when processing a local oscillator signal and an optical return signal, namely during operation of the FMCW LiDAR system. The local oscillator signal and the optical return signal may be mixed in a coupler of a detector of the FMCW LiDAR system. Hence, the beat frequency corresponds to the difference frequency of local oscillator optical signal and return optical signal.

Depending on the development process, the optoelectronic device under test may already comprise the respective components needed for obtaining the beat signal. If not, separately formed components are provided which are part of the test system for certain tests and/or measurements.

Generally, a distance of a target in a scene can be retrieved from the average of the beat frequency during a signal analysis time span. An instantaneous velocity of the target in the scene can be retrieved from the difference of the beat frequencies in up-chirp and down-chirp as this corresponds to the Doppler shift. Other metrics as e.g. target return signal level can be retrieved from the beat signal. The slope (temporal derivative) of the frequency over time is called chirp rate or frequency tuning rate, FTR.

In an embodiment, the carrier frequency of the optical signals are very high frequencies corresponding to optical wavelengths as e.g. around 1550 nm. The frequencies fbu and fbd of the beat signal s(t), which corresponds to the bandwidth of the beat signals, may be up to 1 GHz.

In an embodiment, the beat frequency computation can be done by performing a Fast Fourier Transformation, FFT, on the beat signal during the signal analysis time span, namely by the test and/or measurement instrument.

In an embodiment, a peak detection in the magnitude spectrum will yield fbu in the up-chirp and fbd in the down-chirp. The peak detection may also be done by the test and/or measurement instrument. From these two frequencies the range and velocity in the scene for this pixel can be computed by the test and/or measurement instrument.

For enhanced range and velocity measurements, different chirp sequences may be used, e.g., up, constant wavelength, down. Alternatively, a chirp sequence may consist of a first sub-sequence with a first frequency tuning rate, FTR, also called chirp rate, wherein the first sub-sequence is followed by a second sub-sequence with a second frequency tuning rate, FTR, which differs from the first one. The respective sub-sequences each consist of an up-chirp followed by a down-chirp.

In an embodiment, the test and/or measurement instrument may comprise a processing and analyzing circuit connected with the signal capturing circuit, the synchronizing circuit and the arbitrary waveform generator circuit. The processing and analyzing circuit is configured to process and analyze the at least one analog signal captured from the optoelectronic device under test and to synchronize itself with the synchronizing circuit and the arbitrary waveform generator circuit, respectively. The beat frequency computation can be done by performing a Fast Fourier Transformation, FFT, on the beat signal during the signal analysis time span, namely by the processing and analyzing circuit. The peak detection may also be done by the processing and analyzing circuit. Hence, it is also the processing and analyzing circuit that is configured to compute the range and velocity in the scene for this pixel from the beat frequency fbu in the up-chirp and the beat frequency fbd in the down-chirp.

In an embodiment, the processing and analyzing circuit may be established on an application-specific integrated circuit, ASIC, or by a field programmable gate array, FPGA.

An aspect provides that the test and/or measurement instrument, e.g. the signal capturing circuit, is configured, for example, to detect at least one beat signal from a combination of two optical signals, e.g. when processing and analyzing the at least one analog signal captured from the optoelectronic device under test. The signal capturing circuit may receive an analog signal that corresponds to a combination of two optical signals, based on which the beat signal may be detected. The signal capturing circuit however may also receive a combined signal encompassing the beat signal or the beat signal itself, e.g. from the optoelectronic device under test directly, for example from a detector of the optoelectronic device under test. The respective detector of the optoelectronic device under test may combine two optical signals internally so as to provide the analog signal, which is received by the signal capturing circuit. This depends on the optoelectronic device under test, namely the development process of the FMCW LiDAR system. The beat signal essentially relates to a sinusoidal signal, which is obtained by mixing the optical return signal and the local oscillator signal, as discussed above. In other words, the combination of two optical signals relates to the combination of the optical return signal and the local oscillator signal. This combination/mixing can be done by the optoelectronic device under test itself or by a separately formed component interconnected between the optoelectronic device under test and the test and/or measurement instrument.

In other words, the at least one analog signal from the optoelectronic device under test may relate to an electrical signal outputted by the optoelectronic device under test, namely the beat signal that is provided by the detector of the optoelectronic device under test when processing an internal local oscillator signal and an (alleged) optical return signal.

In an embodiment, the alleged optical return signal may relate to a stimulus signal that is based on a waveform generated by the arbitrary waveform generator circuit.

According to another aspect, the test and/or measurement instrument is configured, for example, to determine a linewidth and/or a phase noise of the analog signal. In an embodiment, the optoelectronic device under test may be an optical generation component of the FMCW LiDAR system, for instance a laser, which is tested. The optical generation component, e.g. laser, may be used for creating the (linear) chirps, e.g. the FMCW based signal component. In an embodiment, the optoelectronic device under test is a device having several optical generation components.

Alternatively, the optoelectronic device under test comprises the optical generation component such that a component of the optoelectronic device under test is tested. Again, this depends on the development process of the FMCW LiDAR system, namely at which point in time of the development the optoelectronic device under test is tested

For instance, the optoelectronic device under test is operated in an open loop mode or a closed loop mode when determining the linewidth and/or the phase noise of the analog signal provided by the optoelectronic device under test. In the open loop mode, a constant current is applied to the optoelectronic device under test, for example the optical generation component. In the closed loop mode however, the optoelectronic device under test, e.g. the optical generation component, is controlled to a constant wavelength, namely stabilized. Actually, this can be achieved by an optical phase locked loop.

In an embodiment, the controlling may be done by the test and/or measurement instrument that is connected with the optoelectronic device under test, also for controlling purposes.

Generally, the deviation from a constant wavelength is a property of the optoelectronic device under test, e.g. the optical generation component, which will lead to deviations from a perfect linear ramp when the optoelectronic device under test is chirped. The deviation of the optoelectronic device under test, namely the optical generation component, from its perfect behavior is usually analyzed in terms of linewidth and/or phase noise.

As already indicated above, the test system may comprise additional components for determining a linewidth and/or a phase noise of the analog signal, for example depending on the development process of the FMCW LiDAR system. For instance, a splitter, a fiber, an acousto-optical modulator, AOM, and/or an (auto-) balanced detector with a coupler may be provided as separately formed components that are interconnected between the optoelectronic device under test and the test and/or measurement instrument. Instead of the (auto-) balanced detector, a coupler together with a single photodiode detector may be used.

Generally, the arbitrary waveform generator circuit may be connected to the acousto-optical modulator, AOM, wherein the arbitrary waveform generator circuit provides a frequency signal for the acousto-optical modulator. The acousto-optical modulator is connected with the splitter that is connected with the optoelectronic device under test, e.g. the optical generation component. Hence, the optical signal provided by the optoelectronic device under test is split by the splitter, wherein a first split optical signal is forwarded to the acousto-optical modulator that modulates the first split optical signal with respect to the signal received from the arbitrary waveform generator circuit, thereby obtaining a modulated signal that is forwarded to the (auto) balanced detector.

Further, the splitter provides a second split optical signal that is forwarded (directly) to the (auto-) balanced detector. The (auto-) balanced detector processes both signals received, namely the second split optical signal and the modulated signal, thereby generating the analog signal that is received by the signal capturing circuit of the test and/or measurement instrument.

In an embodiment, the processing and analyzing circuit of the test and/or measurement instrument is connected with the signal capturing circuit and the arbitrary waveform generator circuit so as to be enabled to determine the linewidth and/or the phase noise of the analog signal.

In an embodiment, standard spectral analysis functions of test and/or measurement instruments can be used. In addition, special functions may be implemented, for instance automated linewidth measurements from (averaged) spectra, fixed model fit functions to fit to the (averaged) spectra where a user can parametrize the fit functions, and/or model fit functions the user can define and customize, e.g. by entering a formula or Python pseudocode. Accordingly, it is possible to retrieve parameters like linewidth and phase noise from (averaged) spectra in combination with the model fit.

A further aspect provides that the test and/or measurement instrument is configured, for example, to determine a chirp linearity of the analog signal. To get a single frequency sinusoidal signal as beat signal, the linear ramp would need to be a perfect chirp without any noise. Due to phase noise, e.g. linewidth limitations, and noise that can be introduced by a control system for creating the linear chirps, the chirp is however not perfect. This means that the instantaneous frequency over time deviates from a line over time. Accordingly, there is a need to assist the customer/user to assess the deviation from a perfect chirp. When doing sequences with varying chirp rates, a control loop needs to re-settle, also called re-lock, when a transition in the chirp rate occurs. The chirp is invalid, namely not linear enough, during these phases and, therefore, the chirp portions cannot be used for measurement purposes. Hence, the relock phase shall not be taken into consideration for linearity assessment.

In general, the linearity assessment can be done based on an analysis of the spectrum of the beat signal and/or based on an analysis of the instantaneous frequency over time of the beat signal. For example, an analytic signal computed via a Hilbert-Transform can be used to compute the instantaneous frequency over time.

In an embodiment, the test system may comprise a Mach-Zehnder-interferometer connected between the optoelectronic device under test and the test and/or measurement instrument. The Mach-Zehnder-interferometer is used for determining a chirp linearity of the analog signal. The Mach-Zehnder interferometer is a device used to determine the relative phase shift variations between two optical signals obtained by splitting an optical signal from a single source. In an embodiment, the Mach-Zehnder interferometer may comprise a delay line, e.g. a delay line with a defined length, for instance 100 m.

For determining the chirp linearity of the analog signal, the test and/or measurement instrument may be connected with the optoelectronic device under test, for example the optical generation component. The optoelectronic device under test, for example the optical generation component, is connected with the Mach-Zehnder-interferometer that is also connected with a detector, e.g. a photodetector. The detector is connected with the signal capturing circuit of the test and/or measurement instrument. The processing and analyzing circuit is connected with the signal capturing circuit and the synchronizing circuit so as to be enabled to determine the chirp linearity.

According to a further aspect, the test and/or measurement instrument is configured, for example, to determine at least partially a spectrum of the analog signal. The test and/or measurement instrument is configured to determine at least partially a spectrogram of the analog signal. The spectrogram is a visual representation of the temporal behavior of the spectrum. Therefore, the spectrum of the analog signal is obtained at different points in time so as to determine the temporal behavior of the spectrum. Generally, meaningful insights of the optoelectronic device under test, e.g. a FMCW LiDAR system, can also be retrieved when analyzing the spectrum/spectrogram of the analog signal, for example the beat signal.

In an embodiment, the same setup used for determining the chirp linearity of the analog signal may be used for determining at least partially a spectrum of the analog signal. Hence, the Mach-Zehnder-interferometer may also be used for determining at least partially a spectrum of the analog signal.

From a record of one or multiple chirps, the following functions may be applied for analysis: (a) Auto-detect regions of constant beat frequency; (b) classify the regions detected in up-down or continuous chirp regions; (c) display the spectrum/spectrogram with the linear chirp regions marked; and (d) enable the user to adjust clustering and acceptance parameters as e.g. which maximum beat frequency variation shall be accepted as constant beat frequency.

Accordingly, an automatic segmentation of the spectrum/spectrogram may be possible. This can be done based only on the beat signal record, namely start of re-locking is determined only based on the beat signal, and/or starting times of the optoelectronic device under test, for example the optical generation component, re-locking are based on a synchronization signal, e.g. from the optoelectronic device under test. As indicated above, the optical generation component may be a laser.

Regarding the setup of the test system described above, the spectrum/spectrogram segmentation can also be applied when an AOM is added to one of the Mach-Zehnder-interferometer arms. The advantage is that the beat frequency in the up-chirp and down-chirp is different even if the chirp rate, also called frequency tuning rate, FTR, in up- and down-chirp has the same magnitude.

For example, if the beat frequency due to Mach-Zehnder-interferometer length is 5 MHz and the AOM provides an 80 MHz frequency shift, the beat frequencies in up-chirp and down-chirp will be 75 MHz (80 MHz minus 5 MHz) and 85 MHz (80 MHz plus 5 MHz). This allows an enhanced segmentation of the spectrum/spectrogram and allows to distinguish between up-chip and down-chirp.

If there is a chirp sequence in an up-scheme, constant wavelength scheme, down-scheme, the frequencies of the beat signal will be 75 MHz, 80 MHz and 85 MHz for the given example.

Other exemplary scenarios, e.g. chirp schemes, may be:
Up with first frequency tuning rate, FTR1: 75 MHZ (80 MHz minus 5 MHz),
Down with first frequency tuning rate, FTR1: 85 MHZ (80 MHz plus 5 MHz),
Up with second frequency tuning rate, FTR2: 77.5 MHz (80 MHz minus 2.5 MHz),
Down with second frequency tuning rate, FTR2: 82,5 MHZ (80 MHZ plus 2.5 MHz.

In an embodiment, the test and/or measurement instrument may be also configured to determine a re-lock time of the optoelectronic device under test, for example a laser re-lock time. It can be assumed that the lock time is the same for all chirps and even for up-chirp and down-chirp. In reality, however, the re-lock times are subject to statistical variations. Thus, the statistical properties of the lock time for an up-chirp, down-chirp and continuous wavelength part differ. Also, re-lock times differ if different chirp rates are used. From the results that arise from spectrum/spectrogram segmentation or a segmentation directly in the time domain, it is also possible to retrieve statistics over the lock time(s) of the optoelectronic device under test, for example the optical generation component. The lock regions are the regions in the spectrum/spectrogram that were not classified as a linear chirp or constant frequency region.

In an embodiment, the analysis function of the test and/or measurement instrument is able to retrieve statistics over the lock time over multiple chirps as e.g. average lock time, maximum lock time, minimum lock time, standard deviation of the lock time, and/or variance of the lock time. In addition, the test and/or measurement instrument is enabled to calculate and/or display a histogram over the lock times, and/or to distinguish between up-chirp lock time statistics, down-chirp lock time statistics and constant-wavelength lock-time statistics.

In an embodiment, quality measures could be also derived in the automatically segmented beat regions. This information can be extracted and provided to the user if desired for each beat region, for instance a signal-to-noise ratio, SNR, namely beat peak over noise floor level, absolute beat peak height, and/or beat frequency variation in different metrics, for instance standard deviation, variance, maximum to minimum and similar.

In an embodiment, the start time of the relock regions can be retrieved automatically from the beat signal processed or a spectrum/spectrogram by applying known algorithms for identifying start times, e.g. triggers.

Alternatively, the start time of the relock can be retrieved from an external synchronization signal provided to the test and/or measurement instrument, for example to the synchronizing circuit. The synchronization signal may be provided by the optoelectronic device under test that is connected with the synchronizing circuit of the test and/or measurement instrument.

In an embodiment, the test and/or measurement instrument may be configured to segment the analog signal in order to obtain at least one chirp segmentation. The test and/or measurement instrument may segment the analog signal into chirp segments with (essentially) constant beat frequency and chirp segments with non-constant beat frequency. The functionalities described above may be performed at least partly offline while accessing a recorded analog signal stored in a memory/storage medium.

However, it might be also beneficial for a customer to find special incidents in locking or chirp quality that happen not often, namely finding outliers in a large/huge amount of chirps, and/or to make statistics over a large amount of consecutive chirps. Therefore a real-time chirp segmentation can be beneficial to allow online statistics computation.

In an embodiment, “special event trigger” on signal properties can be also provided, for example triggering on some chirp linearity parameter out of range, which can be used for system debugging. This would mean for example that a beat frequency out of range or unclear beat frequency is detected. Another example relates to triggering on a relock time that exceeds a threshold in its duration. This would mean triggering after detecting a region in the signal stream in which there is no clear beat frequency for a certain time or longer.

A further aspect provides that the test and/or measurement instrument is configured, for example, to retrieve range and velocity from at least one beat signal. As indicated above, the analog signal received from the optoelectronic device under test may relate to the beat signal. By processing the beat signal, the range and velocity may be determined accordingly. For instance, a customer can select the respective chirp-scheme, e.g. up-constant-down, and provide the frequency tuning rate, FTR, as well as the center wavelength. Then range, velocity and metainfo such as beat peak height in the spectrum can be determined from the beat signal acquisitions. In an embodiment, is possible in connection with beat signal auto-segmentation and/or based on one or more synchronization signals as described above.

In an embodiment, the customer is able to extract a number N of (range, velocity, metadata) measurements from a number of N beat signals for N pixels. The N beat signals can also be represented as one or more acquisitions containing the N beat signals overall. Then the customer can analyze, export or visualize this data.

Alternatively, signal evaluation may be triggered to retrieve range and velocity only on a dedicated pixel during the scan (or the beam pointing at one target in the scene). This allows the assessment of detection probabilities of targets. In order to do so, information like true distance of the target, acceptance range around the true distance, frequency tuning rate of the optoelectronic device under test, and/or number of pixels to assess the detection probability may be provided.

In an embodiment, the test and/or measurement instrument may be configured to provide image creation and/or point cloud creation. As discussed above, range, velocity and metainfo may be computed. In case, synchronization signals are provided to the test and/or measurement instrument, for example the synchronizing circuit, namely from the optoelectronic device under test, image creation or point cloud creation is also possible. This can be very useful for the customer during the development since the final digital signal processing, DSP, component for the optoelectronic device under test is usually available late in the project development or are less suitable for lab and early project use.

Generally, the synchronization signals, e.g. pixel clock, horizontal synchronization, HSYNC, and/or vertical synchronization, VSYNC, can be forwarded to the test and/or measurement instrument via dedicated digital Inputs/Outputs, already available logic analyzer inputs and/or analog inputs of the test and/or measurement instrument.

Typically, the optoelectronic device under test has parallel channels which means that multiple beat signals need to be analyzed in parallel. The test and/or measurement instrument allows images from multiple beat signals connected to multiple inputs, e.g. multiple analog input channels, of the test and/or measurement instrument.

When elevation and azimuth information for all pixels are provided during the scan sequence, also a 3D point cloud visualization can be provided by the test and/or measurement instrument.

In an embodiment, the test and/or measurement instrument may be also configured to provide a noise floor balancing function, namely noise floor compensation. Generally, it is assumed that a beat frequency measurement is done via a detection in magnitude spectra arising from FFTs. However, in some cases noise floor of the beat signal is non-flat in the frequency domain. This could mean that targets are wrongly detected in regions of high noise floor, especially if there is only a very weak target in a frequency region with lower noise floor. By providing a noise floor balancing function, this issue can be overcome. In an embodiment, the beat signal magnitude spectra are multiplied with a weighting function to compensate the noise floor variation. Alternatively or additionally, the noise floor spectrum may be measured and stored in a storage medium of the test and/or measurement instrument. Hence, the stored noise floor spectrum can be used for noise floor compensation during the measurements afterwards.

According to another aspect, the test and/or measurement instrument is configured, for example, to detect the analog signal by applying a constant false alarm rate, CFAR, algorithm. The CFAR algorithm can be used instead of a straightforward peak detection in a beat signal magnitude spectrum. The test and/or measurement instrument allows to the beat frequency basically the “best” peak in a spectrum) according to a CFAR algorithm, use the CFAR for all preceding functions described, e.g. beat frequency measurement, image creation, and so on.

In an embodiment, the test and/or measurement instrument is configured to allow a customer to configure the CFAR algorithm type and all parameters of the CFAR algorithm. Thus, the customer may adapt existing CFAR algorithms to his specific needs.

In an embodiment, the test and/or measurement instrument may be configured to detect multiple peaks in a spectrum per chirp. Multiple peaks, namely targets, in a spectrum per chirp can be detected for the straightforward magnitude peak detection approach as well as for the CFAR algorithm. Moreover, a customer may customize the selection criteria for the peak detection, namely according to which the peaks for range and velocity computation are selected, a simple example the peak with the highest peak height or highest CFAR criterion is selected.

Another aspect provides that the test and/or measurement instrument comprises, for example, a processing module connected with the processing and analyzing circuit. The processing module includes circuitry configured to receive a processed signal of the processing and analyzing circuit for further processing. The processing module may perform analysis of the results obtained after processing by the processing and analyzing circuit, e.g. statistical analysis. Hence, a software processing by the processing module may take place afterwards, namely after processing in hardware.

In an embodiment, the processing module comprises a visualization sub-module configured to provide output data for being visualized. The visualization sub-module generates graphical data that is used for visualization. The graphical data is obtained based on the data processed by the processing and analyzing circuit and, optionally, the processing module.

For instance, the test and/or measurement instrument has at least one user input interface and/or output interface. The output interface may be a display via which the output data for being visualized, namely the graphical data. The user input interface May be provided by the display as well provided that the display is a touch-sensitive display. Alternatively, buttons, knobs and similar are provided via which a user is enabled to set the test and/or measurement instrument appropriately, e.g. selecting a certain test mode for testing the optoelectronic device under test and/or configuring the test and/or measurement instrument. In an embodiment, the at least one user input interface can be used for adapting/customizing default settings of the test and/or measurement instrument.

According to another aspect, the test and/or measurement instrument comprises, for example, a storage medium configured to store data associated with the analog signal. The storage medium may be used for storing acquired signals for offline processing. In addition, settings may be stored in the storage medium which can be accessed by the customer. Furthermore, a noise floor spectrum measured may be stored in the storage medium for being used afterwards so as to perform noise floor compensation.

Generally, the customer may be enabled to re-program the algorithms used by the processing and analyzing circuit of the test and/or measurement instrument. Again, the input interface may be used to adapt or re-program the algorithms used by the processing and analyzing circuit.

According to an embodiment, the test and/or measurement instrument is an oscilloscope. Therefore, known functionalities of oscilloscopes can be used to be applied for testing the optoelectronic device under test. The known functionalities may be extended by the ones described above, for example for testing a FMCW LiDAR system or components thereof.

According to another embodiment, the test and/or measurement instrument is a spectrum analyzer. Therefore, known functionalities of spectrum analyzers can be used to be applied for testing the optoelectronic device under test. The known functionalities may be extended by the ones described above, for example for testing a FMCW LiDAR system or components thereof.

In an embodiment, the optoelectronic device under test may be a frequency-modulated continuous wave, FMCW, light detection and ranging, LiDAR, system. Hence, the LiDAR system or at least a component thereof may be tested by the test and/or measurement instrument.

Generally, the test and/or measurement instrument, being an oscilloscope or a spectrum analyzer, is enabled to determine at least one frequency-modulated continuous wave, FMCW, based signal component, for example to process and to analyze the FMCW based signal component.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a test system for testing an optoelectronic device under test according to an embodiment of the present disclosure, which comprises a test and/or measurement instrument according to an embodiment of the present disclosure;

FIG. 2 schematically shows an overview of an example of an optoelectronic device under test;

FIG. 3 schematically shows an overview of linear up-chirps and linear down-chirps which might be outputted by the optoelectronic device under test;

FIG. 4 schematically shows a test system for testing an optoelectronic device under test according to an embodiment of the present disclosure in an operation mode;

FIG. 5 schematically shows a test system for testing an optoelectronic device under test according to an embodiment of the present disclosure in another operation mode;

FIG. 6 schematically shows an overview of relock times;

FIG. 7 schematically shows an overview for determining linearity and/or phase noise;

FIG. 8 schematically shows an overview of enhanced beat signal record analysis; and

FIG. 9 schematically shows a test system for testing an optoelectronic device under test according to a certain embodiment of the present disclosure in an operation mode for image and point cloud creation.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

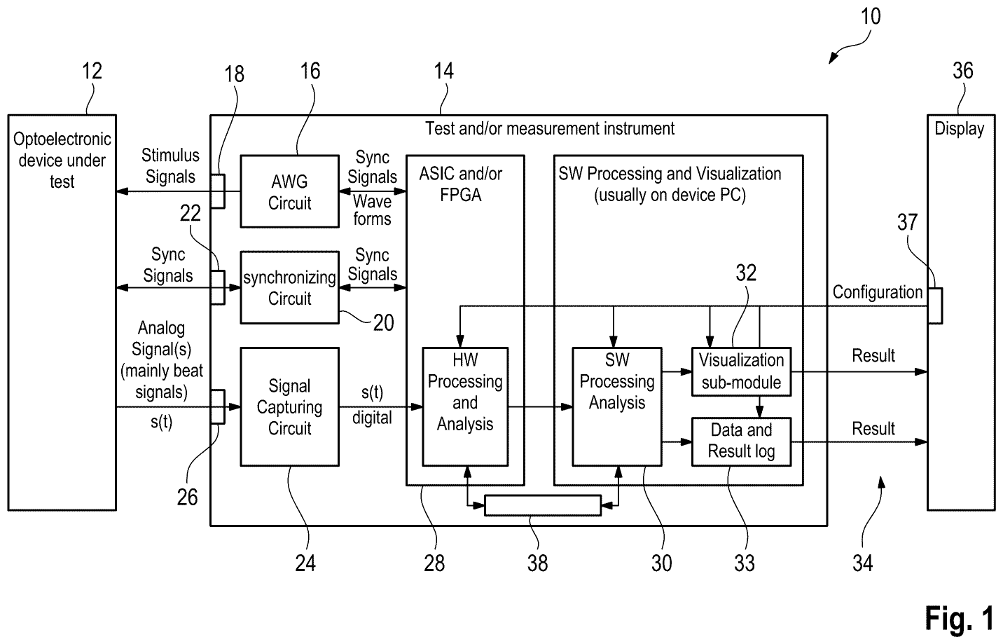

FIG. 1 schematically shows a test system 10 for testing an optoelectronic device under test 12 in accordance with an embodiment of the present disclosure. The optoelectronic device under test 12 may be a frequency-modulated continuous wave, FMCW, light detection and ranging, LiDAR, system or a component thereof. Generally, the FMCW LiDAR system comprises at least an optical generation component, for instance a laser. Hence, the optoelectronic device under test 12 may also relate to the optical generation component itself.

As shown in FIG. 1, the test system 10 comprises a test and/or measurement instrument 14 that can be established by an oscilloscope or a spectrum analyzer. The test and/or measurement instrument 14 comprises an arbitrary waveform generator (AWG) circuit 16 that is configured to provide at least one stimulus signal for the optoelectronic device under test 12. Therefore, the arbitrary waveform generator circuit 16 is associated with an output 18 of the test and/or measurement instrument 14, via which the stimulus signal can be outputted in order to be forwarded to the optoelectronic device under test 12.

The test and/or measurement instrument 14 also comprises a synchronizing circuit 20 that is configured to provide at least one synchronization signal for the optoelectronic device under test 12. The synchronizing circuit 20 may also be configured to receive at least one synchronization signal from the optoelectronic device under test 12. Accordingly, the synchronizing circuit 20 is associated with a bidirectional port 22 of the test and/or measurement instrument 14, via which the test and/or measurement instrument 14 is connected with the optoelectronic device under test 12 in order to exchange synchronization signals. In an embodiment, the synchronizing circuit 20 may comprise a logic analyzer and/or trigger inputs/outputs. In case of an oscilloscope, a mixed signal oscilloscope, MSO, may be provided accordingly.

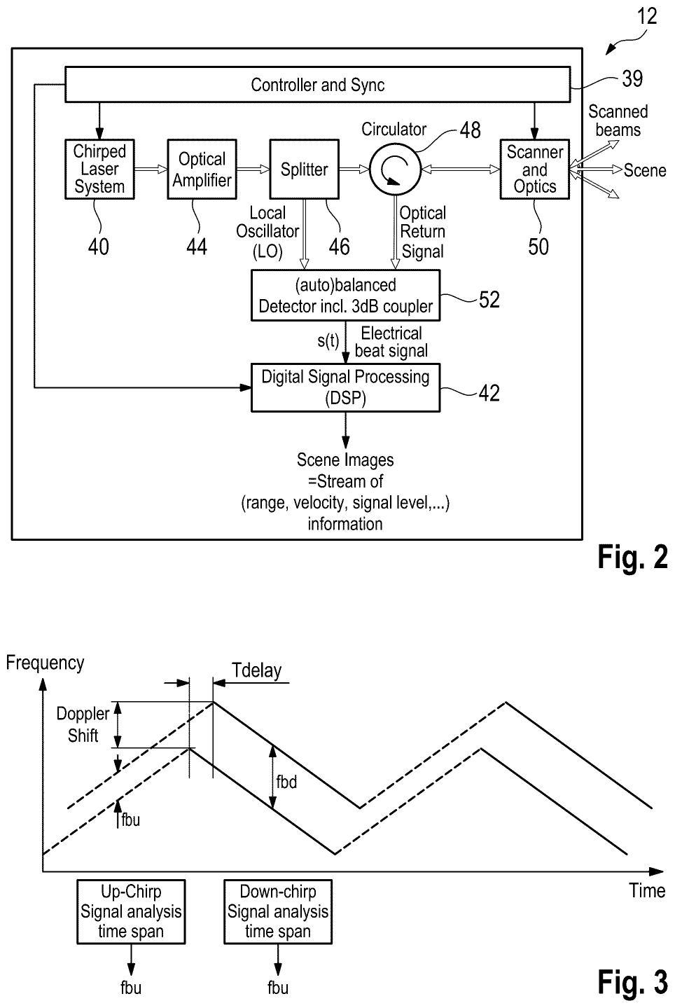

The test and/or measurement instrument 14 also includes a signal capturing circuit 24 that is configured to capture at least one signal from the optoelectronic device under test 12. The signal capturing circuit 24 may be associated with an input 26 of the test and/or measurement instrument 14, which is connected to the optoelectronic device under test 12 for receiving the signal. The signal received via the signal capturing circuit 24 may relate to an analog signal as will be described later in more detail when referring to the details of the optoelectronic device under test 12 shown in FIG. 2.

In the embodiment shown in FIG. 1, the test and/or measurement instrument 14 further comprises at least one processing and analyzing circuit 28 that is connected with the arbitrary waveform generator circuit 16, the synchronizing circuit 20 as well as the signal capturing circuit 24. The processing and analyzing circuit 28 is enabled to process and/or analyze the respective signals received. In an embodiment, the at least one signal captured from the optoelectronic device under test 12 may be processed and analyzed, for example based on the synchronization signals received/provided and/or the stimulus signal outputted.

For this reason, the processing and analyzing circuit 28 is enabled to synchronize itself with the synchronizing circuit 20 and/or the arbitrary waveform generator circuit 16, respectively. Hence, the processing and analyzing circuit 28 obtains the respective information/data to be used for processing and analyzing the (analog) signal captured by the signal capturing circuit 24.

In an embodiment, the processing and analyzing circuit 28 is based on hardware means such that hardware processing and analyzing is provided by the processing and analyzing circuit 28. For instance, the processing and analyzing circuit 28 is implemented on an application-specific integrated circuit, ASIC, and/or a field programmable gate array (FPGA).

Generally, the test and/or measurement instrument 14 is enabled to determine at least one frequency-modulated continuous wave (FMCW) based signal component in the signal received/captured via the signal capturing circuit 24. This is possible since the test and/or measurement instrument 14 comprises the processing and analyzing circuit 28 which processes and analyzes the signal captured appropriately.

As indicated above, the optoelectronic device under test 12 is enabled to output a FMCW based signal component, for instance a combined optical signal like a beat signal.

Accordingly, the test and/or measurement instrument 14, for example the signal capturing circuit 24, is configured to detect at least one beat signal from a combination of two optical signals, e.g. when processing and analyzing the at least one analog signal captured from the optoelectronic device under test 12. In other words, the analog signal may relate to the combined optical signal that is obtained by combining two optical signals. In other words, the analog signal at least comprises the beat signal.

In addition to the processing and analyzing circuit 28, the test and/or measurement instrument 14 also comprises a processing module 30 that is connected with the processing and analyzing circuit 28. In an embodiment, the processing module 30 is located subsequent to the processing and analyzing circuit 28, wherein the processing module 30 provides a software processing, for instance a visualization of the results provided by the processing and analyzing circuit 28.

Accordingly, the processing module 30 may comprise at least one visualization sub-module 32 that is used to generate graphical data used for being outputted. Besides the visualization sub-module 32, the processing module 30 may also comprise a data and result log 33 for at least temporarily storing data/results, for example for making some statistics.

In an embodiment, the test and/or measurement instrument 14 comprises an output interface 34 that may be connected to a separately formed display 36 as indicated in FIG. 1.

Alternatively, the output interface 34 itself may be a display such that the outputted data is displayed directly at the test and/or measurement instrument 14.

The (internal) display of the test and/or measurement instrument 14 may be an input interface 37 as well such that the test and/or measurement instrument 14 has a combined input/output interface provided by the (touch-sensitive) display. Via the input interface 37, the customer/user is enabled to adapt settings of the test and/or measurement instrument 14, e.g. to (re-) configure the test and/or measurement instrument 14.

In an embodiment, the test and/or measurement instrument 14 may comprise a storage medium 38 configured to store data associated with the signal, for instance permanently. Besides this, the storage medium 38 may also store configuration data or other measurement data as will be explained later in more detail.

In an embodiment, the processing and analyzing circuit 28 and/or the processing module 30 may access the storage medium 38 in order to write data into the storage medium 38 and/or to read data from the storage medium 38.

In FIG. 2, a simplified example of the optoelectronic device under test 12 is shown in more detail according to which the optoelectronic device under test 12 is a fully implemented FMCW LiDAR system. As shown in FIG. 2, the optoelectronic device under test 12 comprises a controller 39 (e.g., control circuitry) that is used to control and synchronize an optical generation component 40, for instance a laser, as well as a digital signal processing (DSP) component 42.

In an embodiment, the optical generation component 40 is connected with an optical amplifier 44 that in turn is connected to a splitter 46. The splitter 46 splits the optical signal received into a first split optical signal forwarded to a circulator 48 that is also connected to a scanner and optics 50 in order to output a laser beam. The scanner and optics 50 will also receive an optical return signal that is forwarded to the circulator 48 as well. As shown in FIG. 2, the controller 39 is also used to control and synchronize the scanner and optics 50 accordingly.

The optical return signal forwarded to the circulator 48 is processed by the circulator 48 such that the optical return signal is forwarded to a detector 52, for instance an auto-balanced detector having a coupler. The detector 52 is also connected with the splitter 46 so as to receive a second split optical signal that is provided by the splitter 46. The second split optical signal is also called local oscillator, LO, signal.

The detector 52 processes both signals received, namely the optical return signal and the local oscillator signal, in order to generate an electrical beat signal. In other words, a combination of two optical signals is obtained that is associated with the beat signal. In an embodiment, the optical return signal and the local oscillator (LO) are optically mixed in the 3 dB coupler. This means that the electrical beat signal is essentially a sinusoidal signal. The frequency of the beat signal s(t) is the difference frequency of local oscillator optical signal and return optical signal. This difference frequency is also called the beat frequency of the beat signal s(t).

The beat signal obtained is usually processed by the subsequent digital signal processing (DSP) component 42 in order to generate scene images, namely a stream of information, e.g. range, velocity, signal level and so on, as indicated in FIG. 2.

During development of the optoelectronic device under test 12, the digital signal processing (DSP) component 42 however may not be available. In other words, the digital signal processing (DSP) component 42 is not always provided during a development phase of the optoelectronic device under test 12.

Hence, the electrical beat signal provided by the detector 52 may correspond to the analog signal that is forwarded to the test and/or measurement instrument 14 as shown in FIG. 1 for testing purposes.

It should be noted that the optoelectronic device under test 12 illustrated in FIG. 2 is a simplified illustration, as a real FMCW optoelectronic device typically comprises multiple channels and beams in parallel and/or use photonic integrated circuits (ICs).

Turning to FIG. 3, a simplified concept of the optoelectronic device under test 12 shown in FIG. 2 is illustrated according to which the frequency modulated continuous wave (FMCW) signal provided by the optoelectronic device under test 12 can be assumed to comprise up-chirps as well as down-chirps. As shown in FIG. 3, the respective chirps are linear chirps.

In other words, the simplified concept corresponds to (perfectly) linear chirps provided by the optoelectronic device under test 12. In this case, there is a constant beat frequency fbu in the up-chirp and a constant beat frequency fbd in the down-chirp, as indicated in FIG. 3.

A distance of a target in the scene can be retrieved from the average of the beat frequency during the signal analysis time span. An instantaneous velocity of the target in the scene can be retrieved from the difference of the beat frequencies in up-chirp and down-chirp, as this corresponds to the Doppler shift indicated in FIG. 3. Other metrics like target return signal level can be retrieved from the beat signal as well.

Generally, the slope, namely the temporal derivative, of the frequency over time is called chirp rate or frequency tuning rate, FTR.

The beat frequency computation can be done by performing a Fast Fourier Transform, FFT, on the beat signal s(t) during the signal analysis time span.

A peak detection in the magnitude spectrum will yield fbu in the up-chirp and fbd in the down-chirp. From these two frequencies, the range and velocity in the scene for this pixel can be computed. That means for the example shown in FIG. 3, one pixel is created for one pair of up- and down-chirps. To yield an image with N pixels while the scanner scans over these N pixels there would be N chirp pairs and 2N FFTs would need to be performed.

Accordingly, based on the spectrogram/spectrum, information can be derived that is used for characterizing the optoelectronic device under test 12 by the test and/or measurement instrument 14.

During development of an FMCW optoelectronic device under test 12, there are prototypes built to check the intermediate design stage and make conclusions for the next design steps. These prototypes can be considered to be the optoelectronic device under test 12, as already discussed above.

In an embodiment, the test and/or measurement instrument 14 may generally comprise several different operation modes for testing different characteristics of the optoelectronic device under test 12. In any case, the test and/or measurement instrument 14, for example the processing and analyzing circuit 28, ensures to perform the Fast Fourier Transform, FFT, on the beat signal s(t). In other words, the digital signal processing, DSP, performed by the DSP component 42 may also be performed by the test and/or measurement instrument 14, for example the processing and analyzing circuit 28.

The test and/or measurement instrument 14 shown in FIG. 1 illustrates the common basic architecture that can be used accordingly even though not all components of the test and/or measurement instrument 14 are required for each operation mode as will become clear hereinafter.

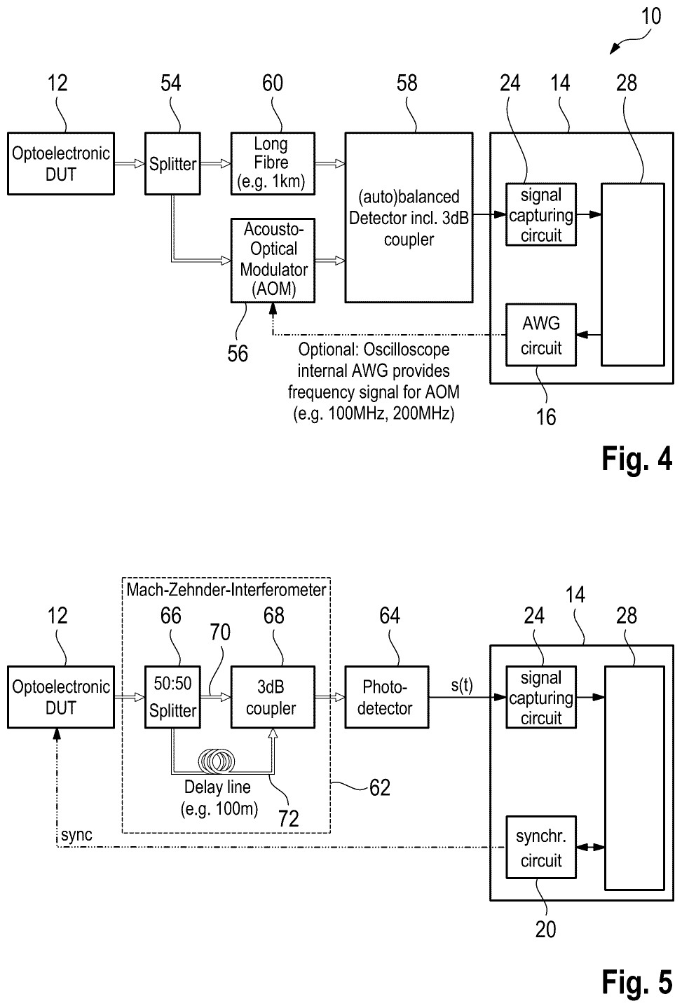

For instance, FIG. 4 shows a first operation mode of the test and/or measurement instrument 14, which is used for performing a linewidth and/or phase noise measurement. The optoelectronic device under test 12 may relate to the optical generation component itself, namely a laser.

Accordingly, the test system 10 further comprises a separately formed splitter 54, an acousto-optical modulator 56 (AOM) as well as a separately formed auto-balanced detector 58 having a coupler. The auto-balanced detector 58 is connected with the splitter 54 by a fiber 60, for instance a fiber of 1 km length.

In other words, the components shown in FIG. 2 located subsequent to the optical generation component 40 (and optionally the optical amplifier 44) are provided by separately formed parts that are located between the optoelectronic device under test 12, namely the optical generation component, and the test and/or measurement instrument 14.

As shown in FIG. 4, the test and/or measurement instrument 14, for example its AWG circuit 16, is connected with the acousto-optical modulator 56. Thus, the stimulus signal provided by the AWG circuit 16 is forwarded to the acousto-optical modulator 56 that also receives a first split optical signal from the splitter 54. Both the first split optical signal and the stimulus signal are processed by the stimulus signal provided by the AWG circuit 16 in order to obtain a modulated signal that is forwarded to the detector 58.

The detector 58 further receives a first split optical signal from the splitter 54 via the fiber 60 such that the detector 58 outputs an analog signal, e.g. the beat signal, which is received by the signal capturing circuit 24 of the test and/or measurement instrument 14. The subsequent processing and analyzing circuit 28 processes the analog signal received in order to determine linewidth and/or phase noise appropriately.

Generally, a 3 dB coupler together with a single photodiode detector may be used instead of the (auto-) balanced detector 58.

In an embodiment, the setup described relates to a Mach-Zehner interferometer, as two arms are provided, namely a first one with a delay line provided by the fiber 60 and a second provided comprising the acousto-optical modulator 56.

Accordingly, it is possible to test the linear chirps provided by the optical generation component at an early stage of the development. These tests can be performed in an open loop mode or a closed loop mode. In the open loop mode, a constant current is applied to the optical generation component, namely the optoelectronic device under test 12. In the closed loop mode, the optical generation component, namely the optoelectronic device under test 12, is stabilized/controlled to a constant wavelength, for instance by an optical phase locked loop.

The deviation from a constant wavelength is a property of the optoelectronic device under test 12, namely the optical generation component, which will lead to deviations from a perfect linear ramp when the optical generation component is chirped. The deviation of the optoelectronic device under test 12, namely the optical generation component, from its perfect behavior is analyzed in terms of linewidth and/or phase noise.

The respective processing and analyzing performed by the test and/or measurement instrument 14, for example the processing and analyzing circuit 28, may comprise spectral analysis as known from oscilloscopes and spectrum analyzers.

In FIG. 5, another setup is shown, wherein the test and/or measurement instrument 14 is connected via its synchronizing circuit 20 with the optoelectronic device under test 12, namely an optical generation component. As shown in FIG. 5, the test system 10 further comprises a Mach-Zehnder-interferometer 62 that is located between the optoelectronic device under test 12 and the test and/or measurement instrument 14. In addition, a photo detector 64 is provided between the Mach-Zehnder-interferometer 62 and the test and/or measurement instrument 14.

The Mach-Zehnder-interferometer 62 has a splitter 66 connected with a coupler 68, wherein two paths are provided between the splitter 66 and the coupler 68, namely a line 70 as well as a delay line 72, e.g. a line with a certain length, for instance 100 m.

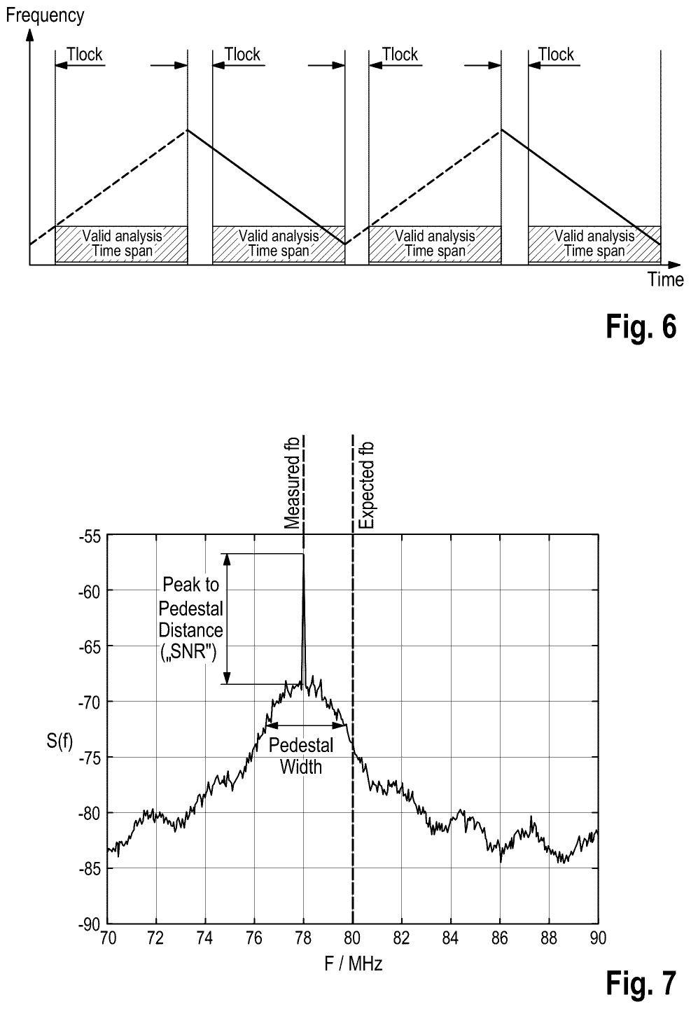

When doing sequences with varying chirp rates usually the control loop needs to re-settle, also called relock, when there is a transition in the chirp rate. During these phases, the chirp is invalid, namely not linear enough, and cannot be used for measurement. The relock phase, Tlock, shall not be taken into consideration for linearity assessment, as shown in FIG. 6.

In an embodiment, the operation of the optoelectronic device under test 12 will yield a constant beat frequency in the beat signal s(t) when the optoelectronic device under test 12, for example the optical generation component, would yield an ideal frequency ramp. The deviations from the ideal ramp will lead to a deviation of the beat signal s(t) from an ideal sinusoidal signal with constant frequency. These deviations can be observed and analyzed by the test and/or measurement instrument 14 in order to assess the linearity and the chirp quality.

According to a first example, a spectral analysis may be performed.

A valid analysis time span, e.g. start and end, for analysis is selected in repeating chirps, see also FIG. 6. These time spans can differ in up-chirp and down-chirp (and possibly further parts with different chirp rates). Further, the number of chirps to perform the analysis on is chosen in order to obtain statistics.

Optionally, a synchronization signal is used, e.g. in both directions between the optoelectronic device under test 12 and the test and/or measurement instrument 14, wherein the synchronization signal determines a reference point in each chirp at which time to start, possibly with a fixed delay, the FFT in each chirp.

Then, the beat frequency and its error band over the time axis is determined and outputted, e.g. the complete record length or averaged over several chirps.

A fit function for the spectrum can be defined/selected in order to retrieve model parameters. Moreover, statistical error parameters are computed in order to characterize the chirp quality. The statistical error parameters may relate to correctness of the average chirp rate, e.g. deviation of the correct delta pulse position in the frequency domain from an ideal value, width of a noise pedestal, a peak to pedestal range, and/or peak to sidelobe range.

FIG. 7 shows a simulated example of how the chirp quality (implicitly linearity, phase noise) can be assessed by spectral analysis. The spectrum shown can be an average over 100 spectra from an up-chirp.

According to a second example, an instantaneous frequency analysis may be performed.

The spectral analysis as described above provide valuable information that is averaged also within the chirp as spectrum/FFT computation implies this. To get information during the chirp itself, the analysis of the instantaneous frequency can be advantageous. For example, the shape of an undesired nonlinearity can be identified and root causes from this result could be concluded.

Statistical parameters in the case of instantaneous frequency analysis can be average chirp rate error, which can be retrieved by measuring the average instantaneous frequency and its deviation from the expected theoretical value, an average mean absolute beat frequency error, an average (root) mean square beat frequency error.

The respective errors can be computed with respect to a desired (theoretically ideal) beat frequency resulting from the Mach-Zehnder-Interferometer path length difference and/or an average beat frequency retrieved from the acquired data.

These statistical parameters are important for characterization as they indicate how good weak return signals, namely weak targets in the scene, can be detected in the final FMCW LiDAR system.

Some FMCW LiDAR systems use nonlinear chirps on purpose. Hence, instantaneous frequency analysis is also beneficial. For instance, the test and/or measurement instrument 14 can also have functions to handle parabolic chirps which means that non-constant beat frequencies during the parabolic chirp need to be processed.

The test and/or measurement instrument 14 can also determine at least partially a spectrum of the analog signal so as to obtain meaningful insights of the optoelectronic device under test 12, e.g. when analyzing the spectrogram of the beat signal. From a record of one or multiple chirps, the test and/or measurement instrument 14, for example the processing and analyzing circuit 28, can auto-detect regions of constant beat frequency as well as classify these regions in up-chirp regions, down-chirp regions or continuous chirp regions. Further, the test and/or measurement instrument 14, for example the processing and analyzing circuit 28 together with the processing module 30, may provide data used for displaying the spectrogram with the linear chirp regions marked. Hence, a customer is able to adjust clustering and acceptance parameters like which maximum beat frequency variation shall be accepted as constant beat frequency.

The automatic segmentation of the spectrum can be done based only on the beat signal record, namely start of re-locking is determined only based on the beat signal, and/or starting times of re-locking are based on a synchronization signal.

Furthermore, the spectrogram segmentation can also be applied when the AOM 56 is added to one of the arms of the Mach-Zehnder-Interferometer 62, as illustrated before.

According to a further operation mode, the re-lock times of the optoelectronic device under test 12 are determined by the test and/or measurement instrument 12.

In FIG. 6, the re-lock times appear to be the same for all chirps. In reality, the re-lock times however differ from each other as they are subject to statistical variations. In addition, the statistical properties of the lock time for an up-chirp, down-chirp and continuous wavelength part differ. In addition thereto, re-lock times differ if different chirp rates are used.

To deal with this issue, the results that arise from spectrogram segmentation or a segmentation directly in the time domain may be processed further in order to retrieve statistics of the lock times of the optoelectronic device under test 12. The lock regions are the regions in the spectrogram that were not classified as a linear chirp or constant frequency region. The test and/or measurement instrument 14 is enabled to retrieve statistics over the lock time over multiple chirps, namely an average lock time, a maximum and minimum lock time, a standard deviation of the lock time, and/or a variance of the lock time.

Based thereon, the test and/or measurement instrument 14 is enabled to determine a histogram over the lock times, which may be displayed.

Generally, the test and/or measurement instrument 14 may also distinguish between up-chirp lock time statistics, down-chirp lock time statistics and constant-wavelength lock-time statistics.

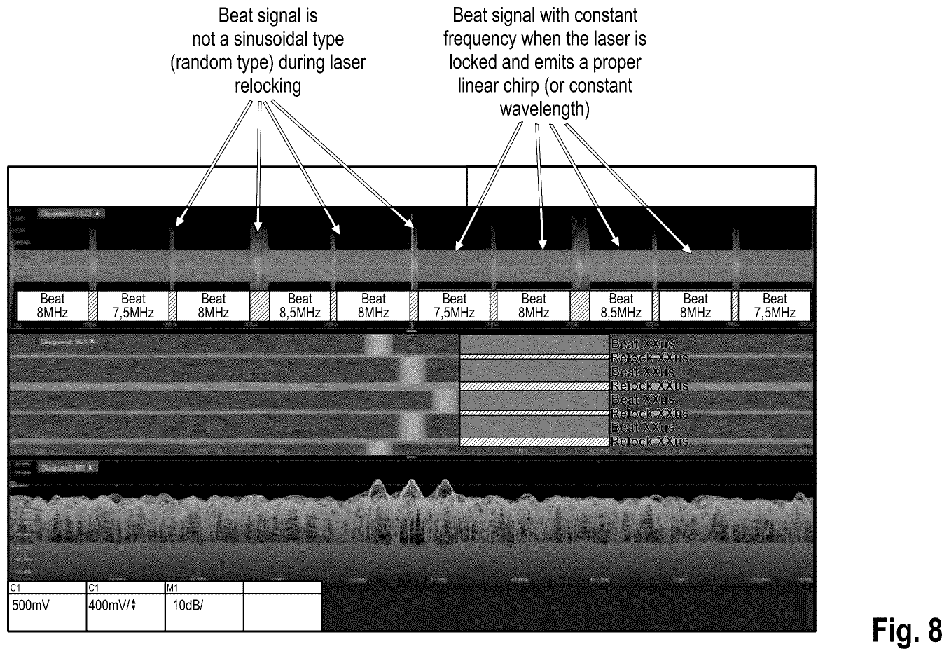

FIG. 8 shows an overview of enhanced beat signal record analysis based on which the above-mentioned information/data is obtained. The different beat frequencies are due to an assumed different FTR of the laser chirps in the different beat regions which correspond to parts of the chirp.

Generally, the test and/or measurement instrument 14 may segment the analog signal, e.g. the beat signal, into chirp segments with (essentially) constant beat frequency and chirp segments with non-constant beat frequency. As discussed before, a classification of the segments/regions detected in continuous chirp regions, e.g. constant frequency regions, may be done such that the other regions may relate to the non-constant frequency regions. Hence, the analog signal can be segmented into chirp segments with (essentially) constant beat frequency and chirp segments with non-constant beat frequency.

In addition, quality measures could be derived in the automatically segmented beat regions. This information can be extracted and provided to the customer via the output interface 34 if desired for each beat region. These quality measures may encompass a signal-to-noise ratio, SNR, namely a beat peak over noise floor level, an absolute beat peak height, and/or a beat peak variation in different metrics, for instance deviation, variance, max-min, and so on.

Generally, the test and/or measurement instrument 14 is enabled to perform offline chirp segmentation, but also real-time chirp segmentation, wherein the real-time chirp segmentation is beneficial to allow online statistics computation.

Accordingly, a “special event trigger” on (beat) signal properties can be beneficial, for instance a triggering on some chirp linearity parameter out of range can be done for debugging purposes. For example, a beat frequency out of range or unclear beat frequency would need to be detected. Alternatively, a triggering on a relock time that exceeds a threshold in its duration may be done. This would mean triggering after detecting a region in the signal stream in which there is no clear beat frequency for a certain time or longer. The “clarity” of a beat signal could for example be quantified by the peak to pedestal height from short time FFTs.

As already indicated above, the test and/or measurement instrument 14 is also enabled to retrieve range and velocity from at least one beat signal, e.g. the FFTs. In an embodiment, the customer can select the chirp-scheme, e.g. up-constant-down, and provide the frequency tuning rate and the center wavelength. Then range, velocity and metainfo as beat peak height in the spectrum can be determined from the beat signal acquisitions. This shall be possible in connection with all features as described before, namely from beat signal auto-segmentation and/or based on one or more synchronization signals.

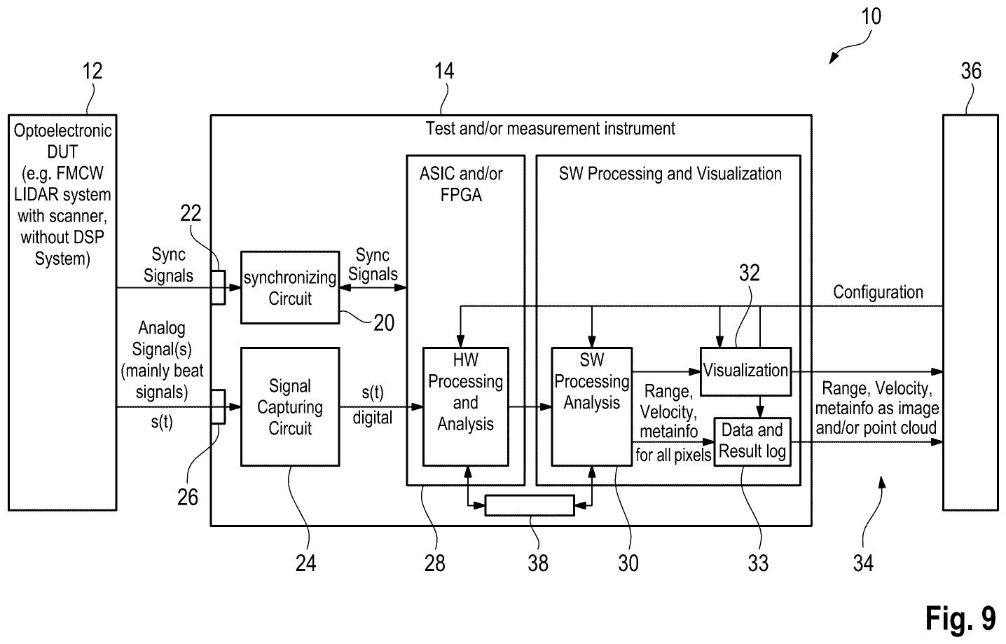

In FIG. 9, a setup is shown that allows creation or point cloud creation. In an embodiment, the optoelectronic device under test 12 relates to a FMCW LiDAR system having a scanner, but no DSP component. As shown in FIG. 9, the test and/or measurement instrument 14 receives synchronization signals from the optoelectronic device under test 12, for instance a pixel clock, a horizontal synchronization, HSYNC, and/or a vertical synchronization, VSYNC. The synchronization signals are received by the synchronizing circuit 20.

In case the customer may provide information with regard to elevation and/or azimuth for all pixels during the scan sequence, the test and/or measurement instrument 14 is also enabled to provide a 3D point cloud visualization.

Generally, the test and/or measurement instrument 14 is also enabled to perform noise floor compensation, e.g. a noise floor balancing function, by measuring a noise spectrum. The noise spectrum may be stored in the storage medium 38 so as to be applied later when receiving the analog signal from the optoelectronic device under test 12. Hence, the noise could be compensated accordingly.

Besides the straightforward peak detection in a beat signal magnitude spectrum, the test and/or measurement instrument 14 may also be enabled to perform a constant false alarm rate (CFAR) algorithm. Provided that the DSP component is not yet obtained, the customer might nevertheless test their optoelectronic device under test 12. Even if the DSP component is already implemented, the customer might test it as well in order to adjust DSP algorithm parameters.

Therefore, the test and/or measurement instrument 14 allows to find the frequency basically the “best” peak in a spectrum) according to a CFAR algorithm. Furthermore, the CFAR may be used for all functions described above, namely beat frequency measurement, image creation, and so on. Moreover, the CFAR algorithm of the optoelectronic device under test 12 may be configured.

Further, the test and/or measurement instrument 14 is also enabled to detect multiple peaks in a spectrum per chirp. For image creation the customer can determine according to which computation scheme the peak selection is done. For instance, the customer might write a script code to be applied by the test and/or measurement instrument 14 for adapting the scheme according to which peaks for range and velocity computation are selected. In a simple example, the peak with the highest peak height (or highest CFAR criterion) is selected.

Generally, the test and/or measurement instrument 14 allows the customizer to adapt the configurations and/or settings so as to customize the test and/or measurement instrument 14 as much as possible to the specific needs, for example the development process. For instance, the customer could re-program the algorithm in the processing and analyzing circuit 28 and/or the processing module 30. For this purpose, the customer may interact with the input interface 27.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiments, these components, or parts thereof, may be grouped in a single location or distributed over a wide area. In circumstances where the components are distributed, the components are accessible to each other via communication links.

In an embodiment, one or more of the components, such as the optoelectronic device under test 12, the test and/or measurement instrument 14, the display 36, etc., referenced above include circuitry programmed to carry out one or more functions disclosed herein. In an embodiments, one or more computer-readable media associated with or accessible by such circuitry contains computer readable instructions embodied thereon that, when executed by such circuitry, cause the component or circuitry to perform one or more of the functions disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A test and/or measurement instrument for testing an optoelectronic device under test, the test and/or measurement instrument comprising:
an arbitrary waveform generator circuit configured to provide at least one stimulus signal for the optoelectronic device under test;
a synchronizing circuit configured to provide at least one synchronization signal for the optoelectronic device under test and/or to receive at least one synchronization signal from the optoelectronic device under test; and
a signal capturing circuit configured to capture at least one analog signal from the optoelectronic device under test,
wherein the test and/or measurement instrument is configured to determine at least one frequency-modulated continuous wave, FMCW, based signal component.

2. The test and/or measurement instrument according to claim 1, further comprising a processing and analyzing circuit connected with the signal capturing circuit, the synchronizing circuit and the arbitrary waveform generator circuit, and wherein the processing and analyzing circuit is configured to process and analyze the at least one analog signal captured from the optoelectronic device under test and to synchronize itself with the synchronizing circuit and the arbitrary waveform generator circuit, respectively.

3. The test and/or measurement instrument according to claim 1, wherein the test and/or measurement instrument is configured to detect at least one beat signal from a combination of two optical signals.

4. The test and/or measurement instrument according to claim 1, wherein the test and/or measurement instrument is configured to determine a linewidth and/or a phase noise of the analog signal.

5. The test and/or measurement instrument according to claim 1, wherein the test and/or measurement instrument is configured to determine a chirp linearity of the analog signal.

6. The test and/or measurement instrument according to claim 1, wherein the test and/or measurement instrument is configured to determine at least partially a spectrum of the analog signal.

7. The test and/or measurement instrument according to claim 1, wherein the test and/or measurement instrument is configured to determine a re-lock time of the optoelectronic device under test.

8. The test and/or measurement instrument according to claim 1, wherein the test and/or measurement instrument is configured to segment the analog signal in order to obtain at least one chirp segmentation.

9. The test and/or measurement instrument according to claim 1, wherein the test and/or measurement instrument is configured to retrieve range and velocity from at least one beat signal.

10. The test and/or measurement instrument according to claim 1, wherein the test and/or measurement instrument is configured to provide image creation and/or point cloud creation.

11. The test and/or measurement instrument according to claim 1, wherein the test and/or measurement instrument is configured to provide a noise floor balancing function.

12. The test and/or measurement instrument according to claim 1, wherein the test and/or measurement instrument is configured to detect the analog signal by applying a constant false alarm rate, CFAR, algorithm.

13. The test and/or measurement instrument according to claim 1, wherein the test and/or measurement instrument is configured to detect multiple peaks in a spectrum per chirp.

14. The test and/or measurement instrument according to claim 1, further comprising a processing module connected with the processing and analyzing circuit, wherein the processing module is configured to receive a processed signal of the processing and analyzing circuit for further processing.

15. The test and/or measurement instrument according to claim 1, wherein the test and/or measurement instrument has at least one user input interface and/or output interface.

16. The test and/or measurement instrument according to claim 1, further comprising a storage medium configured to store data associated with the analog signal.

17. The test and/or measurement instrument according to claim 1, wherein the test and/or measurement instrument is an oscilloscope or a spectrum analyzer.

18. A test system for testing an optoelectronic device under test, the test system comprising the optoelectronic device under test and the test and/or measurement instrument according to claim 1.

19. The test system according to claim 18, wherein the optoelectronic device under test is operated in an open loop mode or a closed loop mode when determining a linewidth and/or a phase noise of the analog signal provided by the optoelectronic device under test.

20. The test system according to claim 18, further comprising a Mach-Zehnder-interferometer connected between the optoelectronic device under test and the test and/or measurement instrument, and wherein the Mach-Zehnder-interferometer is used for determining a chirp linearity of the analog signal and/or for determining at least partially a spectrum of the analog signal.
